(19) United States
(12) Patent Application Publication
(10) Pub. No.: US 2025/0182917 A1
(43) Pub. Date: Jun. 5, 2025

(54) NUCLEAR REACTOR SHUTDOWN SYSTEM AND METHOD OF NUCLEAR REACTOR SHUTDOWN

(71) Applicant: MITSUBISHI HEAVY INDUSTRIES, LTD., Tokyo (JP)

(72) Inventors: Shohei Otsuki, Tokyo (JP); Satoru Kamohara, Tokyo (JP); Tadakatsu Yodo, Tokyo (JP); Shota Kobayashi, Tokyo (JP); Nozomu Murakami, Tokyo (JP); Wataru Nakazato, Tokyo (JP); Keisuke Sano, Tokyo (JP); Daisuke Fujiwara, Tokyo (JP); Hirokazu Sugiura, Tokyo (JP); Yutaka Tanaka, Tokyo (JP); Tatsuo Ishiguro, Tokyo (JP); Hironori Noguchi, Tokyo (JP); Tsuyoshi Tokairin, Tokyo (JP); Takanori Karato, Tokyo (JP); Takahiro Miyamoto, Tokyo (JP)

(73) Assignee: MITSUBISHI HEAVY INDUSTRIES, LTD., Tokyo (JP)

(21) Appl. No.: 18/840,739

(22) PCT Filed: Dec. 26, 2022
(86) PCT No.: PCT/JP2022/047997

§ 371 Date: Aug. 22, 2024

(30) Foreign Application Priority Data
Mar. 3, 2022 (JP) 2022-032592

(51) Int. Cl. G21C 9/02; G21C 7/22; G21C 9/027

(52) U.S. Cl. CPC G21C 9/024; G21C 7/22; G21C 9/027

(57) ABSTRACT

A nuclear reactor shutdown system includes a housing vessel that is disposed above a reactor core fuel housed in a nuclear core vessel in a hermetically sealed manner, houses a plurality of neutron absorbers, and has an opening enabling the neutron absorbers to pass through at a bottom, a shielded path that passes through the reactor core fuel to extend in an up-and-down direction, an upper end of the shielded path communicating with the opening of the housing vessel and a lower end of the shielded path being closed, and a communicating part that is disposed so as to close the opening and causes the housing vessel and the shielded path to communicate with each other when the communicating part reaches or exceeds a threshold temperature.

### FIELD

The present disclosure relates to a nuclear reactor shutdown system and a method of nuclear reactor shutdown.

### BACKGROUND

In a nuclear power generation system using a nuclear fuel and utilizing heat from a nuclear reaction to generate electricity, heat generated in a nuclear reactor is recovered by a primary cooling system in which a primary coolant circulates between the nuclear reactor and a secondary cooling system, heat exchange is performed between the primary coolant and a secondary coolant, and a turbine provided in the secondary cooling system is rotated by the energy of the secondary coolant, thus generating electricity. Such nuclear facilities include a system for termination of the nuclear reaction in the nuclear reactor in an emergency. For example, Patent Literature 1 discloses a fuel assembly including a control element pin including a neutron absorber fixed at the top by a stopper melting when reactor output increases. In nuclear reactors including such a fuel assembly, the stopper melts when the reactor output increases, causing the neutron absorber to fall into a fuel part to shut down the nuclear reactor.

### CITATION LIST

### Patent Literature

Patent Literature 1: Japanese Patent Application Laid-open No. S62-47585

### SUMMARY

### Technical Problem

In recent years, facilities using relatively small-sized nuclear reactors have been considered as power generation facilities and the like using nuclear reactors. For example, a micro reactor has been developed that does not have the primary cooling system in which the primary coolant circulates but has a heat conduction part conducting heat in a nuclear reactor vessel to the outside through solid-state heat conduction. When such a small-sized nuclear reactor is used, it may be difficult to use conventional nuclear reactor shutdown systems without modification.

The present disclosure solves the problem described above, and an object thereof is to provide a nuclear reactor shutdown system and a method of nuclear reactor shutdown for reactor scram that can be used for small-sized nuclear reactors while maintaining safety and quickness.

### Solution to Problem

To achieve the above-described object, a nuclear reactor shutdown system according to one aspect of the present disclosure includes:
a housing vessel that is disposed above a reactor core fuel housed in a nuclear core vessel in a hermetically sealed manner, houses a plurality of neutron absorbers, and has an opening enabling the neutron absorbers to pass through at a bottom;
a shielded path that passes through the reactor core fuel to extend in an up-and-down direction, an upper end of the shielded path communicating with the opening of the housing vessel and a lower end of the shielded path being closed; and
a communicating part that is disposed so as to close the opening and causes the housing vessel and the shielded path to communicate with each other when the communicating part reaches or exceeds a threshold temperature.

To achieve the above-described object, a method of nuclear reactor shutdown according to one aspect of the present disclosure is for: a housing vessel that is disposed above a reactor core fuel housed in a nuclear core vessel in a hermetically sealed manner, houses a plurality of neutron absorbers, and has an opening enabling the neutron absorbers to pass through at a bottom; a shielded path that passes through the reactor core fuel to extend in an up-and-down direction, an upper end of the shielded path communicating with the opening of the housing vessel and a lower end of the shielded path being closed; and a communicating part that is disposed so as to close the opening and causes the housing vessel and the shielded path to communicate with each other when the communicating part reaches or exceeds a threshold temperature, and includes causing the neutron absorbers housed in the housing vessel to fall down into the shielded path through the opening when the communicating part reaches or exceeds the threshold temperature and thus the housing vessel and the shielded path communicate with each other.

### Advantageous Effects of Invention

The present disclosure can produce an effect of being capable of being used for small-sized nuclear reactors while maintaining safety and quickness.

### BRIEF DESCRIPTION OF DRAWINGS

FIG. 1 is a schematic diagram of a schematic configuration of a nuclear power generation system according to the present embodiment.

FIG. 2 is a schematic diagram of a schematic configuration of a nuclear reactor shutdown system according to the present embodiment.

FIG. 3 is a schematic diagram of a state in which the nuclear reactor shutdown system illustrated in FIG. 2 has worked.

FIG. 4 is a schematic diagram of another example of the nuclear reactor shutdown system.

FIG. 5 is a schematic diagram of another example of the nuclear reactor shutdown system.

FIG. 6 is a schematic diagram of another example of the nuclear reactor shutdown system.

### DESCRIPTION OF EMBODIMENTS

### Embodiment

The following describes an embodiment according to the present disclosure in detail based on the accompanying drawings. This invention is not limited by this embodiment. In addition, the components in the following embodiment include ones that those skilled in the art can replace and easy, substantially the same ones, and ones within the range of equivalence. Furthermore, the components in the following embodiment can be omitted, replaced, or changed in various ways to the extent not departing from the gist of the present disclosure. In the following embodiment, the components that are necessary to exemplify the embodiment are described, other components are omitted, the same components are denoted by the same symbols, and different components are denoted by different symbols.

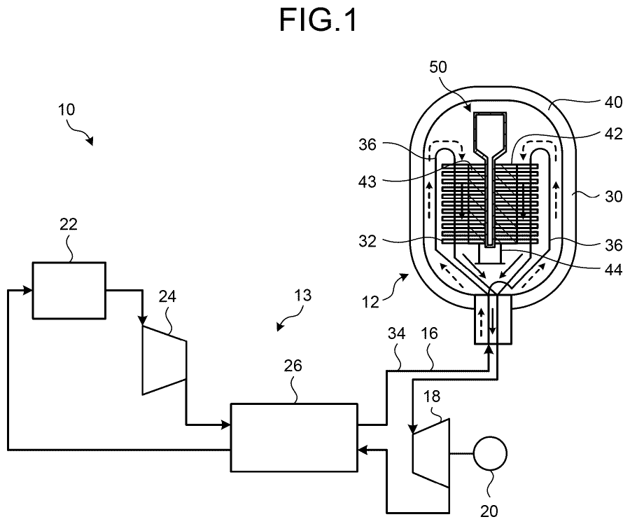

FIG. 1 is a schematic diagram of a schematic configuration of a nuclear power generation system according to the present embodiment. This nuclear power facility illustrated in FIG. 1 is described as a case of nuclear power generation generating electricity using heat generated by a nuclear reactor, but the present disclosure is not limited to this case. It can also be used for facilities using the heat generated by the nuclear reactor for purposes other than power generation. In addition, it can also be used as a facility producing radioactive materials using radiation generated by the nuclear reactor. This nuclear power generation system 10 illustrated in FIG. 1 includes a nuclear reactor unit 12 and a power generation unit 13. The power generation unit 13 has a coolant circulation unit 16, a turbine 18, a generator 20, a cooler 22, a compressor 24, and a regenerative heat exchanger 26.

The nuclear reactor unit 12 has a nuclear reactor 30, a heat conduction part 32, and a nuclear reactor shutdown system 50. The nuclear reactor 30 has a nuclear reactor vessel 40, a reactor core fuel 42, and a control unit 44. The nuclear reactor vessel 40 houses the reactor core fuel 42 inside. The nuclear reactor vessel 40 houses the reactor core fuel 42 in a hermetically sealed manner. The nuclear reactor vessel 40 is provided with an opening-and-closing part to allow insertion and removal of the reactor core fuel 42 to be placed inside. The opening-and-closing part is, for example, a lid. The nuclear reactor vessel 40 can remain the hermetically sealed state even when a nuclear reaction occurs inside and the inside reaches a high temperature and a high pressure. The nuclear reactor vessel 40 is formed of a material having blocking performance for neutron rays and is formed thick enough to prevent neutron rays generated inside from leaking to the outside. The nuclear reactor vessel 40 is formed of, for example, concrete. The nuclear reactor vessel 40 may contain an element having highly blocking performance, such as boron.

The reactor core fuel 42 includes a plurality of fuel holding plates 43. The fuel holding plates 43 have a plurality of nuclear fuels placed inside. The fuel holding plates 43 are formed of a material conducting heat generated by the nuclear fuels. Graphite, silicon carbide, or the like can be used for the fuel holding plates 43. The reactor core fuel 42 produces reaction heat as the nuclear fuel undergoes a nuclear reaction.

The control unit 44 has a blocking member movable through the reactor core fuel 42. The blocking member is what is called a control rod including functions of blocking radiation and inhibiting a nuclear reaction. The nuclear reactor 30 controls the reaction of the reactor core fuel 42 by moving control unit 44 and adjusting the position of the blocking member.

As illustrated in FIG. 1, the heat conduction part 32 is disposed inside the nuclear reactor vessel 40 and is in contact with the fuel holding plates 43. The heat conduction part 32 of the present embodiment has a plurality of plates and has a structure in which they are alternately stacked with the fuel holding plates 43. The heat conduction part 32 has plates larger in external shape than the fuel holding plates 43 and protrudes into the area in which the fuel holding plates 43 are not disposed. Here, for the heat conduction part 32, for example, titanium, nickel, copper, graphite, or graphene can be used.

For the heat conduction part 32, graphene arranged in an orientation facilitating heat conduction in a direction along the surface of the plate is preferably used in order to increase the efficiency of heat conduction to the protruding parts. The heat conduction part 32 conducts heat through solid-state heat conduction. That is, the heat conduction part 32 conducts heat without using a heat medium (fluid). Specifically, the heat conduction part 32 conducts heat generated by the reactor core fuel 42 to the power generation unit 13 through solid-state heat conduction.

In the nuclear reactor unit 12, a nuclear reaction occurs in the reactor core fuel 42 inside the nuclear reactor 30, generating reaction heat. The generated heat is stored inside the nuclear reactor vessel 40, and the inside reaches a high temperature. In the nuclear reactor unit 12, part of the heat generated in the nuclear reactor 30 is conducted to the heat conduction part 32. The heat conduction part 32 heats a coolant flowing in the coolant circulation unit 16 of the power generation unit 13. As the coolant, carbon dioxide (CO₂) is preferably used.

The nuclear reactor shutdown system 50 is a system for emergency termination of the nuclear reaction of the reactor core fuel 42. The detailed configuration of the nuclear reactor shutdown system 50 of the embodiment is described below.

The coolant circulation unit 16 has a circulation path 34 circulating outside the nuclear reactor vessel 40 and a heat exchanging part 36 circulating inside the nuclear reactor vessel 40. The coolant circulation unit 16 is circulated by the circulation path 34 and the heat exchanging part 36, which form a closed loop. The circulation path 34 is a path circulating the coolant outside the nuclear reactor vessel 40 and connects the turbine 18, the cooler 22, the compressor 24, and the regenerative heat exchanger 26 to each other. The heat exchanging part 36 is inserted into the nuclear reactor vessel 40 and disposed inside. Both ends of the heat exchanging part 36 are exposed outside the nuclear reactor vessel 40 and are connected to the circulation path 34. The heat exchanging part 36 is a conduit through which the coolant circulates and is in contact with the area of the heat conduction part 32 that is not in contact with the reactor core fuel 42. In other words, the heat exchanging part 36 is in contact with the part of the heat conduction part 32 protruding beyond the reactor core fuel 42. The heat exchanging part 36 exchanges heat with the heat conduction part 32 to heat the coolant.

The coolant flowing through the coolant circulation unit 16 is supplied to the heat exchanging part 36. The nuclear power generation system 10 exchanges heat between the heat conduction part 32 and the coolant supplied from the coolant circulation unit 16. A heat exchanger of the present embodiment includes the heat conduction part 32 and the heat exchanging part 36 of the coolant circulation unit 16. The heat exchanger recovers the heat of the heat conduction part 32 by the coolant flowing through the coolant circulation unit 16. In other words, the coolant is heated by the heat conduction part 32. The heat medium heated by the heat exchanging part 36 flows through the turbine 18, the cooler 22, the compressor 24, and the regenerative heat exchanger 26 in this order. The coolant having passed through the regenerative heat exchanger 26 is again supplied to the heat exchanging part 36. The coolant is thus circulated through the coolant circulation unit 16.

Into the turbine 18, the coolant having passed through the heat conduction part 32 flows. The turbine 18 is rotated by the energy of the heated coolant. In other words, the turbine 18 converts the energy of the coolant into rotational energy to absorb energy from the coolant. The generator 20 is coupled to the turbine 18 and rotates in unison with the turbine 18. The generator 20 generates electricity by rotating with the turbine 18.

The cooler 22 cools the coolant having passed through the turbine 18. The cooler 22 is a chiller or, when the coolant is temporarily liquefied, a condenser or the like. The compressor 24 is a pump pressurizing the coolant. The regenerative heat exchanger 26 exchanges heat between the coolant having passed through the turbine 18 and the coolant having passed through the compressor 24. The regenerative heat exchanger 26 heats the coolant having passed through the compressor 24 by the coolant having passed through the turbine 18. In other words, the regenerative heat exchanger 26 exchanges heat between the coolant before being cooled by the cooler 22 and the coolant after being cooled by the cooler 22, recovering heat discarded by the cooler 22 by the coolant before being supplied to the nuclear reactor unit 12.

In the nuclear power generation system 10, the heat generated by the reaction of the nuclear fuel in the nuclear reactor unit 12 is conducted to the coolant in the heat exchanging part 36 by the heat conduction part 32 and heats the coolant flowing through the coolant circulation unit 16 by the heat of the heat conduction part 32. In other words, the coolant absorbs the heat conducted by the heat conduction part 32. The heat generated in the nuclear reactor unit 12 is thereby conducted by the heat conduction part 32 through solid-state heat conduction and is recovered by the coolant. After being compressed by the compressor 24, the coolant is heated and compressed while passing through the heat conduction part 32, and the heated energy rotates the turbine 18. Subsequently, the coolant is cooled to a standard state by the cooler 22 and is again supplied to the compressor 24.

As described above, the nuclear power generation system 10 conducts the heat of the nuclear reactor 30 to the coolant as a medium rotating the turbine 18 by using the heat conduction part 32 conducting heat through solid-state heat conduction.

By using carbon dioxide as the coolant, the nuclear power generation system 10 can prevent contamination of the coolant even when the coolant is circulated inside the nuclear reactor 30. This can reduce the risk of contamination of the medium rotating the turbine 18. In addition, by providing the heat conduction part 32 conducting heat through solid-state heat conduction, a neutron beam can be blocked by the heat conduction part 2.

The nuclear reactor vessel 40 is preferably formed of a material with lower thermal conductivity than that of the heat conduction part 32. This can prevent heat inside the nuclear reactor 30 from being discharged to the outside from parts other than the heat conduction part 32, which is the path for discharging heat to the outside.

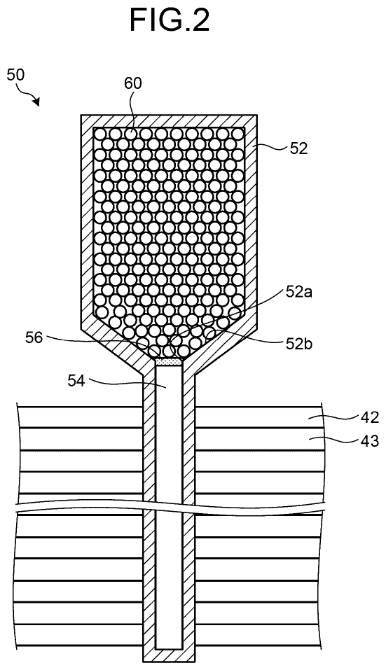

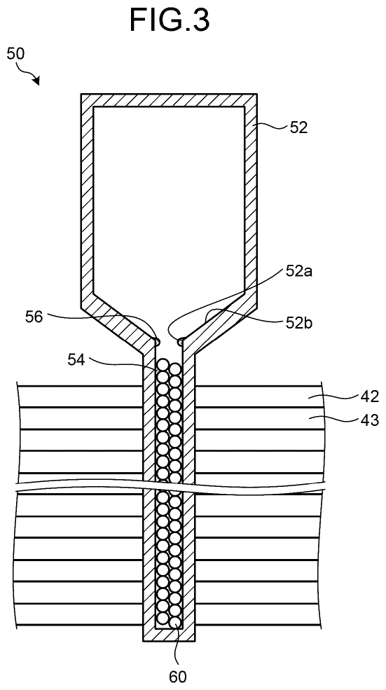

FIG. 2 is a schematic diagram of a schematic configuration of a nuclear reactor shutdown system according to the present embodiment. FIG. 3 is a schematic diagram of a state in which the nuclear reactor shutdown system illustrated in FIG. 2 has worked. This nuclear reactor shutdown system 50 includes a neutron absorber 60, a housing vessel 52, a shielded path 54, and a communicating part 56.

The neutron absorber 60 is a material containing, for example, boron (B), cadmium (Cd), xenon (Xe), or hafnium (Hf) absorbing neutrons. In the embodiment, the neutron absorber 60 is a plurality of solid spheres, but their individual shapes are not limited to a particular shape so long as they can move minutely and independently and may include, for example, an oval or rod-like shape. They are not limited to solids and may include gels, liquids, and gases, but they are preferably solid spheres. As illustrated in FIG. 3, the neutron absorbers 60 reduce neutrons absorbed by the nuclear fuel and can inhibit a nuclear reaction or shut down the nuclear reactor 30 by being inserted into a reactor core.

The housing vessel 52 is positioned above the reactor core fuel 42. The housing vessel 52 houses a plurality of the neutron absorbers 60. The housing vessel 52 has an opening 52a at the bottom. The opening 52a is at least larger in diameter than the neutron absorbers 60 and enables the neutron absorbers 60 to pass through. The opening 52a of the embodiment is positioned at the center of the housing vessel 52 in the horizontal direction. The housing vessel 52 of the embodiment has a tapered inclined inner wall 52b gradually tapering toward the opening 52a.

The shielded path 54 is a path passing through the reactor core fuel 42 to extend in an up-and-down direction. An upper end of the shielded path 54 communicates with the opening 52a at the bottom of the housing vessel 52. A lower end of the shielded path 54 is closed. As illustrated in FIG. 3, the shielded path 54 can house the neutron absorbers 60 having fallen through the opening 52a of the housing vessel 52. The shielded path 54 of the embodiment is formed at the center of the reactor core extending in the vertical direction.

As illustrated in FIG. 2, the communicating part 56 is disposed so as to close the opening 52a at the bottom of the housing vessel 52. As illustrated in FIG. 2, the communicating part 56, when it is lower than a certain threshold temperature, maintains the state in which the opening 52a is sealed. As illustrated in FIG. 3, when reaching or exceeding the threshold temperature, the communicating part 56 opens the opening 52a. The communicating part 56 is formed of, for example, a material melting or degenerating at the threshold temperature or higher. The communicating part 56 is formed of a material the melting point of which is the temperature during the rated operation of the nuclear reactor vessel 40 or higher. The communicating part 56 is formed of, for example, metal such as brass.

The communicating part 56 may have, for example, a plate shape melting to open a hole or degenerating to break away from the opening 52a at the threshold temperature or higher. The communicating part 56 may include, for example, an outer peripheral part fixed along the periphery of the opening 52a and a plate-shaped inner peripheral part melting to open a hole or degenerating to break away from the outer peripheral part at the threshold temperature or higher. In the communicating part 56, for example, at least the outer peripheral part may degenerate to break away from the opening 52a at the threshold temperature or higher. The communicating part 56 may include, for example, a valve body opening at the threshold temperature or higher.

The nuclear reactor shutdown system 50 maintains the temperature of the communicating part 56 lower than the threshold temperature during the rated operation of the nuclear reactor 30. In this state, the communicating part 56 closes the opening 52a of the housing vessel 52, and thus the neutron absorbers 60 remain kept inside the housing vessel 52.

In the nuclear reactor shutdown system 50, if an abnormality occurs in the nuclear reactor 30 and the temperature in the nuclear reactor vessel 40 rises, and thereby the temperature of the communicating part 56 reaches or exceeds the threshold temperature, as illustrated in FIG. 3, the communicating part 56 opens the opening 52a of the housing vessels 52. When the opening 52a is opened, the neutron absorbers 60 in the housing vessel 52, which have been kept by the communicating part 56, fall down into the shielded path 54 through the opening 52a.

The neutron absorbers 60 having fallen down into the shielded path 54, that is, having reached the inside of the reactor core absorb the neutrons in the reactor core to inhibit the nuclear reaction of the reactor core fuel 42. The shielded path 54 is filled with the neutron absorbers 60 one after another, and the neutron absorbers 60 absorb the neutrons in the reactor core, thereby stopping the nuclear reaction of the reactor core fuel 42.

In the nuclear reactor shutdown system 50 of the embodiment, the housing vessel 52 has an inclined inner wall 52b toward the opening 52a, and the neutron absorbers 60 are solid spheres, and thus the neutron absorbers 60 can roll on the inclined inner wall 52b. This can prevent the neutron absorbers 60 from clogging at the opening 52a when the neutron absorbers 60 fall down from the opening 52a one after another.

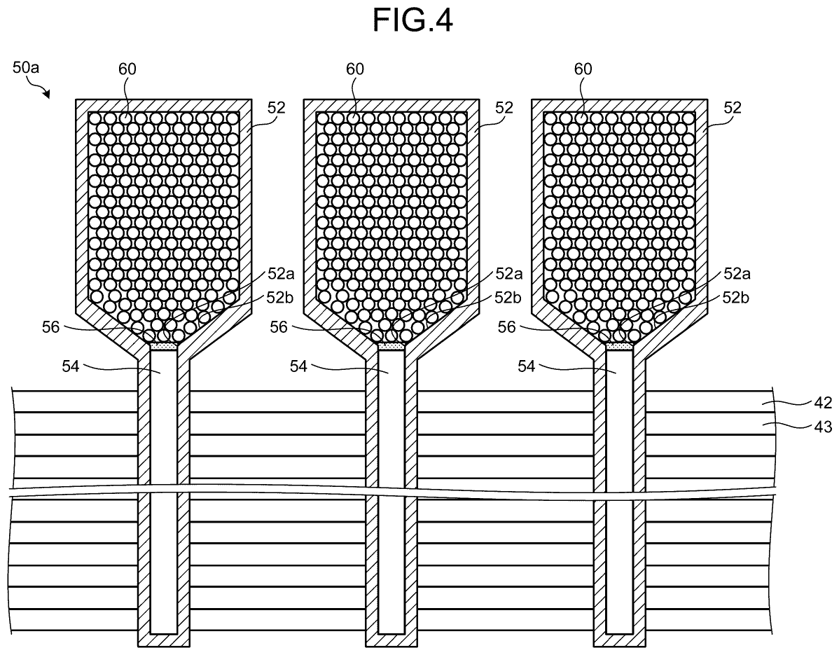

FIG. 4 is a schematic diagram of another example of the nuclear reactor shutdown system. This nuclear reactor shutdown system 50a illustrated in FIG. 4 differs from the nuclear reactor shutdown system 50 illustrated in FIG. 2 and FIG. 3 in that it includes a plurality of sets (three sets in the example illustrated in FIG. 4) of the housing vessel 52, the shielded path 54, and the communicating part 56. Each of the housing vessels 52, each of the shielded paths 54, and each of the communicating parts 56 each have the same configuration as each part of the nuclear reactor shutdown system 50, and thus a detailed description is omitted.

The housing vessels 52 are disposed side by side in the horizontal direction above the reactor core fuel 42. Each of the housing vessels 52 houses the neutron absorbers 60. The shielded paths 54 are disposed side by side in the horizontal direction so as to pass through the reactor core fuel 42. One communicating part 56 is disposed at the boundary between the opening 52a of each of the housing vessels 52 and the upper end of each of the shielded paths 54.

In the nuclear reactor shutdown system 50a, the temperature of each of the communicating parts 56 is maintained lower than the threshold temperature during the rated operation of the nuclear reactor 30 (refer to FIG. 1). In this state, each of the communicating parts 56 closes the opening 52a of each of the housing vessels 52, and thus the neutron absorbers 60 remain kept inside each of the housing vessels 52.

In the nuclear reactor shutdown system 50a, if an abnormality occurs in the nuclear reactor 30 (refer to FIG. 1) and the temperature in the nuclear reactor vessel 40 (refer to FIG. 1) rises and the temperature of any of the communicating parts 56 reaches or exceeds the threshold temperature, the communicating part 56 the temperature of which has reached or exceeded the threshold temperature opens the opening 52a of the corresponding housing vessel 52. When the opening 52a is opened, the neutron absorbers 60 in the housing vessel 52, which have been kept by the communicating part 56, fall down into the shielded path 54 through the opening 52a.

Each of the communicating parts 56, when reaching or exceeding the threshold temperature, opens the opening 52a of the corresponding housing vessel 52. After the corresponding opening 52a is opened, the neutron absorbers 60 having fallen down into the shielded path 54, that is, having reached the inside of the reactor core absorb the neutrons in the reactor core to inhibit the nuclear reaction of the reactor core fuel 42. Each of the shielded paths 54 is filled with the neutron absorbers 60 one after another, and the neutron absorbers 60 absorb the neutrons in the reactor core, thereby stopping the nuclear reaction of the reactor core fuel 42.

Thus, in the nuclear reactor shutdown system 50a, at least one of the communicating parts 56 opens the opening 52a of the corresponding housing vessel 52, and thereby the neutron absorbers 60 housed in at least one of the housing vessels 52 fall down into the corresponding shielded path 54. That is, the nuclear reactor shutdown system 50a, even if any of the communicating parts 56 causes a trouble and fails to open the opening 52a or if the neutron absorbers 60 clog at the opening 52a, can allow the neutron absorbers 60 to be introduced into the reactor core fuel 42 from another housing vessel 52.

The nuclear reactor shutdown system 50a illustrated in FIG. 4 includes three sets of the housing vessel 52, the shielded path 54, and the communicating part 56, but it may include two sets or four or more sets. All the housing vessels 52, all the shielded paths 54, and all the communicating parts 56 are each not necessarily the same in shape and size. For example, the shielded path 54 positioned at the center of the reactor core fuel 42 in the horizontal direction may be provided thicker than the surrounding shielded paths 54.

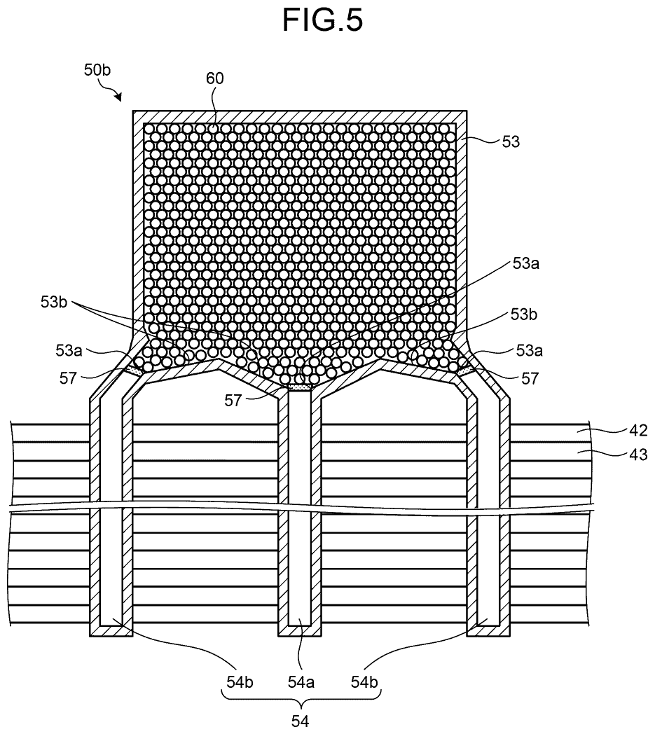

FIG. 5 is a schematic diagram of another example of the nuclear reactor shutdown system. This nuclear reactor shutdown system 50b illustrated in FIG. 5 differs from the nuclear reactor shutdown system 50 illustrated in FIG. 2 and FIG. 3 in that it includes a housing vessel 53 instead of the housing vessel 52, that the shielded path 54 includes a plurality of (three in the example illustrated in FIG. 5) shielded paths 54a, 54b, and 54b, and that it includes a plurality of (three in the example illustrated in FIG. 5) communicating parts 56.

The following describes components of the housing vessel 53 different from those of the housing vessel 52 illustrated in FIG. 2 and FIG. 3 and omits detailed descriptions of the same components. The housing vessel 53 has a plurality of (three in the example illustrated in FIG. 5) openings 53a at the bottom. Each of the openings 53a is at least larger in diameter than the neutron absorbers 60 and enables the neutron absorbers 60 to pass through. One openings 53a is positioned at the center of the housing vessel 53 in the horizontal direction, and the other two openings 53a are positioned near the outer peripheral part of the housing vessel 52. The housing vessel 53 has a tapered inclined inner wall 53b gradually tapering toward each of the openings 53a.

The shielded path 54 includes the shielded path 54a and the shielded paths 54b. The shielded path 54a is a path passing through the central part of the reactor core fuel 42 to extend in the up-and-down direction. An upper end of the shielded path 54a communicates with the opening 53a disposed at the central part of the bottom of the housing vessel 53. A lower end of the shielded path 54a is closed. The shielded path 54a can house the neutron absorbers 60 having fallen down through the opening 53a disposed at the central part of the housing vessel 53.

The shielded paths 54b are paths passing through the parts separated from the central part of the reactor core fuel 42 in the horizontal direction to extend in the up-and-down direction. Upper ends of the shielded paths 54b communicate with the respective openings 53a disposed near the outer peripheral part of the bottom of the housing vessel 53. The parts near the upper ends of the shielded paths 54b bend inward toward the top. Lower ends of the shielded paths 54b are closed. The shielded paths 54b can house the neutron absorbers 60 having fallen down through the openings 53a disposed near the outer peripheral part of the housing vessel 53.

The following describes components of the communicating parts 57 different from those of the communicating part 56 illustrated in FIG. 2 and FIG. 3 and omits detailed descriptions of the same components. The communicating parts 57 are disposed so as to close the openings 53a of the housing vessel 53. One communicating part 56 is disposed at each of the openings 53a. The communicating parts 57, when they are lower than the certain threshold temperature, maintain the state in which the corresponding openings 53a, at which they are disposed, are sealed. The communicating parts 57, when reaching or exceeding the threshold temperature, open the corresponding openings 53a, at which they are disposed.

The nuclear reactor shutdown system 50b maintains the temperature of each of the communicating parts 57 lower than the threshold temperature during the rated operation of the nuclear reactor 30 (refer to FIG. 1). In this state, each of the communicating parts 57 closes each of the openings 53a of the housing vessel 53, and thus the neutron absorbers 60 remain kept inside the housing vessel 53.

In the nuclear reactor shutdown system 50b, if an abnormality occurs in the nuclear reactor 30 (refer to FIG. 1) and the temperature in the nuclear reactor vessel 40 (refer to FIG. 1) rises and the temperature of any of the communicating parts 57 reaches or exceeds the threshold temperature, the communicating part 57 the temperature of which has reached or exceeded the threshold temperature opens the corresponding opening 53a of the housing vessel 53. When any of the openings 53a is opened, the neutron absorbers 60 in the housing vessel 52, which have been kept by the communicating parts 57, fall down into the shielded path 54a or 54b through the opened opening 53a.

The communicating parts 57, when each of them reaches or exceeds the threshold temperature, open the corresponding opening 53a of the housing vessel 53. After the corresponding opening 53a is opened, the neutron absorbers 60 having fallen down into the shielded path 54a or 54b, that is, having reached the inside of the reactor core absorb the neutrons in the reactor core to inhibit the nuclear reaction of the reactor core fuel 42. Each of the shielded paths 54a and 54b is filled with the neutron absorbers 60 one after another, and the neutron absorbers 60 absorb the neutrons in the reactor core, thereby stopping the nuclear reaction of the reactor core fuel 42.

Thus, in the nuclear reactor shutdown system 50b, at least one of the communicating parts 57 opens the corresponding opening 53a, thereby causing the neutron absorbers 60 housed in the housing vessel 53 to fall down into the shielded path 54 corresponding to the opened opening 53a. That is, the nuclear reactor shutdown system 50b, even if any of the communicating parts 57 causes a trouble and fails to open the opening 53a or if the neutron absorbers 60 clog at the opening 53a, can allow the neutron absorbers 60 to be introduced into the reactor core fuel 42 from another opening 53a.

The nuclear reactor shutdown system 50b illustrated in FIG. 5 includes three sets of the shielded path 54 and the communicating part 57, but it may include two sets or four or more sets. All the shielded paths 54 and all the communicating parts 57 are each not necessarily the same in shape and size. For example, the shielded path 54a positioned at the center of the reactor core fuel 42 in the horizontal direction may be provided thicker than the surrounding shielded paths 54b.

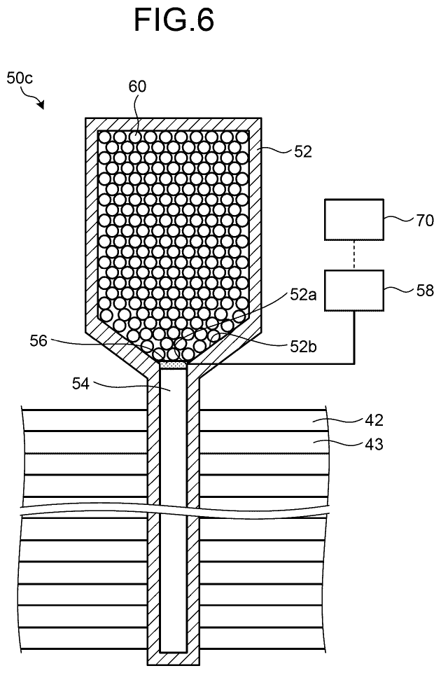

FIG. 6 is a schematic diagram of another example of the nuclear reactor shutdown system. This nuclear reactor shutdown system 50c illustrated in FIG. 6 further includes a heating unit 58 and a controller 70 in addition to the components of the nuclear reactor shutdown system 50 illustrated in FIG. 2 and FIG. 3. The following describes the heating unit 58 and the controller 70, which are unique components of the nuclear reactor shutdown system 50c, and omits detailed descriptions of the same components as in the nuclear reactor shutdown system 50.

The heating unit 58 can heat the communicating part 56 up to the threshold temperature or higher based on a control signal received from the controller 70. The configuration and the method of heating of the heating unit 58 are not limited to particular ones. For example, the communicating part 56 may be heated by directly energizing it or heated through heat radiation from a heat source that is heated by energization.

The controller 70 sends the control signal for heating the communicating part 56 to the heating unit 58. The controller 70 may send the control signal for heating the communicating part 56 when a certain operation by an operator is received. When detecting some abnormality, the controller 70 may send the control signal for heating the communicating part 56 based on certain criteria. The controller 70 may be included as a partial function of a control system controlling the operation of the nuclear reactor unit 12 or included in conjunction with the nuclear reactor unit 12 or the nuclear power generation system 10, for example, as a partial function of an auxiliary power source system when an abnormality occurs.

### Effects of Embodiment

The nuclear reactor shutdown system 50, 50a, 50b, or 50c and the method of nuclear reactor shutdown described in the embodiment are understood, for example, as follows.

The nuclear reactor shutdown system 50, 50a, 50b, or 50c according to the first aspect includes the housing vessel 52 or 53 disposed above the reactor core fuel 42 housed in the nuclear reactor vessel 40 in a hermetically sealed manner, housing a plurality of the neutron absorbers 60, and having an opening 52a or 53a enabling the neutron absorbers 60 to pass through at a bottom, the shielded path 54, 54a, or 54b passing through the reactor core fuel 42 to extend in an up-and-down direction, an upper end of which communicating with the opening 52a or 53a of the housing vessel 52 or 53 and a lower end of which being closed, and the communicating part 56 or 57 disposed so as to close the opening 52a or 53a and causing the housing vessel 52 or 53 and the shielded path 54, 54a, or 54b to communicate with each other when reaching or exceeding a threshold temperature.

The nuclear reactor shutdown system 50, 50a, 50b, or 50c according to the first aspect releases the holding of the neutron absorbers 60 when the communicating part 56 or 57 holding the neutron absorbers 60 reaches or exceeds the threshold temperature along with a temperature rise in the nuclear reactor vessel 40 in the event of an abnormality. That is, when the communicating part 56 or 57 reaches or exceeds the threshold temperature and thus the neutron absorbers 60 fall down into the reactor core fuel 42 without requiring any special control functions, so that the nuclear reaction can be passively inhibited to shut down the function safely and quickly in the event of an abnormal temperature rise in the nuclear reactor vessel 40. The neutron absorbers 60 are not a single mass of material but a plurality of materials that can pass through the opening 52a or 53a, thus giving flexibility in its overall shape in a state of being held by the communicating part 56 or 57. That is, the housing vessel 52 housing the neutron absorbers 60 has a flexible shape and can be shortened in the longitudinal direction (the direction in which the neutron absorbers 60 are introduced into the reactor core fuel 42), enabling it to be used even for small-sized nuclear reactors.

The nuclear reactor shutdown system 50, 50a, 50b, or 50c according to a second aspect is provided in the nuclear reactor unit 12 including the nuclear reactor 30 including the reactor core fuel 42 and the nuclear reactor vessel 40 and the heat conduction part 32 disposed inside the nuclear reactor vessel 40 and configured to conduct the heat of the reactor core fuel 42 through solid-state heat conduction. The nuclear reactor shutdown system 50, 50a, 50b, or 50c can achieve a configuration in which, when the communicating part 56 or 57 reaches or exceeds the threshold temperature, the neutron absorbers 60 fall down into the reactor core fuel 42 without requiring any special control functions. Thus, the nuclear reactor shutdown system 50, 50a, 50b, or 50c can also be used for the nuclear reactor unit 12 conducting the heat of the reactor core fuel 42 through solid-state heat conduction.

In the nuclear reactor shutdown system 50, 50a, 50b, or 50c according to a third aspect, the communicating part 56 or 57 is formed of a material melting or degenerating at the threshold temperature or higher. Such a communicating part 56 or 57 melts to open a hole or degenerates to break away from the outer peripheral part at the threshold temperature or higher. This can achieve a configuration in which the opening 52a or 53a of the housing vessel 52 or 53 is opened when the communicating part 56 or 57 reaches or exceeds the threshold temperature with a simple configuration.

In the nuclear reactor shutdown system 50, 50a, 50b, or 50c according to a fourth aspect, the housing vessel 52 or 53 has the tapered inclined inner wall 52b or 53b gradually tapering toward the opening 52a or 53a. When the opening 52a or 53a of the housing vessel 52 or 53 is opened and the neutron absorbers 60 fall down from the opening 52a or 53a one after another, the neutron absorbers 60 in the housing vessel 52 or 53 slide or roll on the inclined inner wall 52b or 53b, and thereby the neutron absorbers 60 can be prevented from being kept in the housing vessel 52 or 53 or clogging at the opening 52a or 53a.

In the nuclear reactor shutdown system 50, 50a, 50b, or 50c according to a fifth aspect, the neutron absorbers 60 are solid spheres. This enables the neutron absorbers 60 to roll on the bottom of the housing vessel 52 or 53, and thus when the opening 52a or 53a of the housing vessel 52 or 53 is opened and the neutron absorbers 60 fall down from the opening 52a or 53a one after another, they can be prevented from clogging at the opening 52a or 53a.

The nuclear reactor shutdown system 50a according to a sixth aspect includes a plurality of sets of the housing vessel 52, the shielded path 54, and the communicating part 56. Thus, at least one of the communicating parts 56 opens the opening 52a of the corresponding housing vessel 52, thereby causing the neutron absorbers 60 housed in at least one of the housing vessels 52 to fall down into the corresponding shielded path 54. That is, even if any of the communicating parts 56 causes a problem and fails to open the opening 52a or if the neutron absorbers 60 clog at the opening 52a, the neutron absorbers 60 can be introduced into the reactor core fuel 42 from another housing vessel 52.

In the nuclear reactor shutdown system 50b according to a seventh aspect, the housing vessel 53 has a plurality of openings 53a, a plurality of shielded paths 54, 54a, or 54b are disposed so as to communicate with the respective openings 53a, and a plurality of sets of the communicating part 57 are provided in accordance with the openings 53a. Thus, by at least one of the communicating parts 57 opening the corresponding opening 53a, the neutron absorbers 60 housed in the housing vessel 53 fall down into the shielded path 54, 54a, or 54b corresponding to the opened opening 53a. That is, even if any of the communicating parts 57 causes a problem and fails to open the opening 53a or if the neutron absorbers 60 clog at the opening 53a, the neutron absorbers 60 can be introduced into the reactor core fuel 42 from another openings 53a.

The nuclear reactor shutdown system 50c according to an eighth aspect further includes the heating unit 58 capable of heating the communicating part 56 up to the threshold temperature or higher and the controller 70 configured to send a control signal for heating the communicating part 56 to the heating unit 58. That is, even when the communicating part 56 has not risen to the threshold temperature in the event of an abnormality, if a further temperature rise in the nuclear reactor vessel 40 is predicted or if another abnormality is detected, the nuclear reaction can be inhibited to shut down the function safely and quickly in an aggressive manner as well.

The method of nuclear reaction shutdown according to a ninth aspect, in the housing vessel 52 or 53 disposed above the reactor core fuel 42 housed in the nuclear reactor vessel 40 in a hermetically sealed manner, housing a plurality of the neutron absorbers 60, and having an opening 52a or 53a enabling the neutron absorbers 60 to pass through at a bottom, the shielded path 54, 54a, or 54b passing through the reactor core fuel 42 to extend in an up-and-down direction, an upper end of which communicating with the opening 52a or 53a of the housing vessel 52 or 53 and a lower end of which being closed, and the communicating part 56 or 57 disposed so as to close the opening 52a or 53a and causing the housing vessel 52 or 53 and the shielded path 54, 54a, or 54b to communicate with each other when reaching or exceeding a threshold temperature, the method includes causing the neutron absorbers 60 housed in the housing vessel 52 or 53 to fall down into the shielded path 54, 54a, or 54b through the opening 52a or 53a when the communicating part 56 or 57 reaches or exceeds the threshold temperature and thus the housing vessel 52 or 53 and the shielded path 54, 54a, or 54b communicate with each other.

The method of nuclear reactor shutdown according to the ninth aspect releases the holding of the neutron absorbers 60 when the communicating part 56 or 57 holding the neutron absorbers 60 reaches or exceeds the threshold temperature along with a temperature rise in the nuclear reactor vessel 40 in the event of an abnormality. That is, when the communicating part 56 or 57 reaches or exceeds the threshold temperature and thus the neutron absorbers 60 fall down into the reactor core fuel 42 without requiring any special control functions, so that the nuclear reaction can be passively inhibited to shut down the function safely and quickly in the event of an abnormal temperature rise in the nuclear reactor vessel 40. The neutron absorbers 60 are not a single mass of material but a plurality of materials that can pass through the opening 52a or 53a, thus giving flexibility in its overall shape in a state of being held by the communicating part 56 or 57. That is, the housing vessel 52 housing the neutron absorbers 60 has a flexible shape and can be shortened in the longitudinal direction (the direction in which the neutron absorbers 60 are introduced into the reactor core fuel 42), enabling it to be used even for small-sized nuclear reactors.

The above has described the embodiment of the present disclosure, but the embodiment is not limited by the descriptions of the embodiment.

### REFERENCE SIGNS LIST

10 Nuclear power generation system
12 Nuclear reactor unit
13 Power generation unit
14 Heat exchanger
16 Coolant circulation unit
18 Turbine
20 Generator
22 Chiller (cooler)
24 Pump (compressor)
26 Regenerative heat exchanger
30 Nuclear reactor
32 Heat conduction part
34 Circulation path
36 Heat exchanging part
40 Nuclear reactor vessel
42 Reactor core fuel
43 Fuel holding plate
44 Control unit
50, 50a, 50b, 50c Nuclear reactor shutdown system
52, 53 Housing vessel
52a, 53a Opening
52b, 53b Inclined inner wall
54, 54a, 54b Shielded path
56, 57 Communicating part
58 Heating unit
60 Neutron absorber
70 Controller

1. A nuclear reactor shutdown system comprising:
a housing vessel that is disposed above a reactor core fuel housed in a nuclear core vessel in a hermetically sealed manner, houses a plurality of neutron absorbers, and has an opening enabling the neutron absorbers to pass through at a bottom;
a shielded path that passes through the reactor core fuel to extend in an up-and-down direction, an upper end of the shielded path communicating with the opening of the housing vessel and a lower end of the shielded path being closed; and
a communicating part that is disposed so as to close the opening and causes the housing vessel and the shielded path to communicate with each other when the communicating part reaches or exceeds a threshold temperature.

2. The nuclear reactor shutdown system according to claim 1, provided in a nuclear reactor unit that comprises:
a nuclear reactor that includes the reactor core fuel and the nuclear reactor vessel; and
a heat conduction part that is disposed inside the nuclear reactor vessel and is configured to conduct heat of the reactor core fuel through solid-state heat conduction.

3. The nuclear reactor shutdown system according to claim 1, wherein the communicating part is formed of a material melting or degenerating at the threshold temperature or higher.

4. The reactor shutdown system according to claim 1, wherein the housing vessel has a tapered inclined inner wall gradually tapering toward the opening.

5. The nuclear reactor shutdown system according to claim 1, wherein the neutron absorbers are solid spheres.

6. The nuclear reactor shutdown system according to claim 1, comprising a plurality of sets of the housing vessel, the shielded path, and the communicating part.

7. The nuclear reactor shutdown system according to claim 1, wherein
the housing vessel has a plurality of the openings,
the shielded path includes a plurality of shielded paths disposed so as to communicate with the respective openings, and
the communicating part includes a plurality of sets of the communicating part in accordance with the openings.

8. The nuclear reactor shutdown system according to claim 1, further comprising:
a heating unit that is configured to heat the communicating part up to the threshold temperature or higher; and
a controller that is configured to send a control signal for heating the communicating part to the heating unit.

9. A method of nuclear reactor shutdown for a system that includes:
a housing vessel that is disposed above a reactor core fuel housed in a nuclear core vessel in a hermetically sealed manner, houses a plurality of neutron absorbers, and has an opening enabling the neutron absorbers to pass through at a bottom;
a shielded path that passes through the reactor core fuel to extend in an up-and-down direction, an upper end of the shielded path communicating with the opening of the housing vessel and a lower end of the shielded path being closed; and
a communicating part that is disposed so as to close the opening and causes the housing vessel and the shielded path to communicate with each other when the communicating part reaches or exceeds a threshold temperature, the method comprising
causing the neutron absorbers housed in the housing vessel to fall down into the shielded path through the opening when the communicating part reaches or exceeds the threshold temperature and thus the housing vessel and the shielded path communicate with each other.
